(19) United States
(12) Patent Application Publication
(10) Pub. No.: US 2025/0163347 A1
(43) Pub. Date: May 22, 2025

(54) DEFOAMER FORMULATIONS CONTAINING TRIACYLGLYCERIDES

(71) Applicant: Wacker Chemie AG, Munich (DE)

(72) Inventors: Christof BREHM, Burghausen (DE); Nikolai Denkov DENKOV, Sofia (BG); Vasil Stefanov GEORGIEV, Sandanski (BG); Andreas MEIER, Burgkirchen (DE); Slavka Stoyanova TCHOLAKOVA, Sofia (BG); Stefan WOLFRUM, Mühldorf (DE); Johannes ZIRZLMEIER, Burghausen (DE)

(73) Assignee: Wacker Chemie AG, Munich (DE)

(21) Appl. No.: 18/840,103

(22) PCT Filed: Mar. 1, 2022
(86) PCT No.: PCT/EP2022/055066

§ 371 Date: Aug. 21, 2024

(51) Int. Cl. C11D 3/00; B01D 19/04; C11D 3/12; C11D 3/20; C11D 3/37; C11D 17/00

(52) U.S. Cl. CPC C11D 3/0026; B01D 19/0404; B01D 19/0409; C11D 3/124; C11D 3/2093; C11D 3/3738; C11D 17/0017

(57) ABSTRACT

A defoamner formulation (A) includes (1) 100 parts by weight of triacylglycerides of the formula

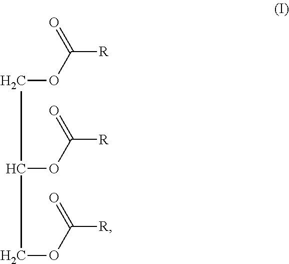

where R may be the same or different and is a saturated or unsaturated C₅-C₁₃ hydrocarbon radical. The defoamer formulation (A) includes at least 1 part by weight and at most 25 parts by weight of fillers, based on 100 parts by weight of (1). The defoamer formulation (A) includes at least 1 part by weight and at most 25 parts by weight of organopolysiloxane resins, based on 100 parts by weight of (1), composed of units of the general formula R²ₑ(R³O)_{f}SiO(_{4-e-f)/2} (II). The sum of e+f is less than or equal to 3 and in less than 50% of all units of the formula (II) in the organopolysiloxane resin the sum of e+f is equal to 2.

The invention relates to defoamer formulations comprising triacylglycerides and use thereof as defoamers, in particular in aqueous surfactant systems.

In many liquid, especially aqueous, systems, which comprise surface-active compounds as desirable or else undesirable constituents, problems due to foaming may occur if these systems are brought into more or less intensive contact with gaseous substances, for example when sparging wastewaters, when intensively stirring liquids, in distillation, washing or coloring processes or during dispensing procedures.

Controlling this foam may be accomplished mechanically or by the addition of defoamers. The most successful defoamer formulations, especially for detergents, are based on silicones.

There is a certain demand for defoamer formulations that comprise a reduced amount of organopolysiloxane or are free of organopolysiloxanes. U.S. Pat. No. 5,693,256 A and EP 1 703 958 B1 describe organopolysiloxane-free defoamer formulations in which a water-insoluble organic liquid together with hydrophobic fillers and a siloxane resin is used instead of the organopolysiloxanes. In addition to isoparaffin oil, fatty acid esters or mineral oil, the water-insoluble organic liquid used in these patents can also be a vegetable oil. Rapeseed oil and peanut oil are described as vegetable oils. Vegetable oils are triacylglycerides in which three fatty acid radicals are bonded together to a glycerol radical via ester bonds. Rapeseed oil is a triacylglyceride, the fatty acid radicals of which are predominantly oleic acid, linoleic acid, linolenic acid and palmitic acid radicals, i.e. C16 or C18 fatty acid radicals. The same applies to peanut oil, which consists predominately of oleic acid, linoleic acid and palmitic acid radicals, i.e. also of C16 or C18 fatty acid radicals.

In U.S. Pat. No. 5,693,256 A and in EP 1 703 958 B1, the defoamer formulations described are used, in addition to black liquor defoaming or foam destruction in cutting oil processes, primarily for foam control during the washing cycle in the washing machine for laundry washing.

In the applications described, the defoamer formulations based on rapeseed oil or peanut oil exhibit a quite good effect.

In the course of the improvement process of such defoamer formulations, however, it became apparent that in applications in which cationic surfactants are used, or in applications in which spreading plays an important role, for example in the rinsing cycle of the washing process, the foam regulating compositions based on triacylglycerides having predominantly C16 or C18 fatty acid radicals, such as the rapeseed oil or peanut oil described, exhibit a very weak effect or no effect.

The object was to provide defoamer formulations that do not have the aforementioned disadvantages. The object is achieved by the invention.

The invention therefore provides defoamer formulations (A) comprising
(1) triacylglycerides of the formula

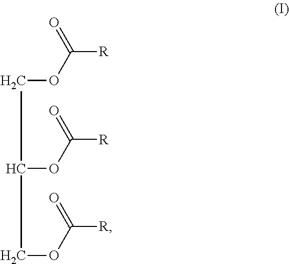

where
R may be the same or different and is a saturated or unsaturated C₅-C₁₃ hydrocarbon radical,
(2) fillers,
(3) organopolysiloxane resins composed of units of the general formula

R²ₑ(R³O)_{f}SiO_{(4-e-f)/2} (II),
where
R² may be the same or different and is a hydrogen atom or a monovalent, optionally substituted, SiC-bonded hydrocarbon radical having 1 to 30 carbon atoms,
R³ may be the same or different and is a hydrogen atom or a monovalent, optionally substituted, hydrocarbon radical having 1 to 4 carbon atoms,
e is 0, 1, 2 or 3 and
f is 0, 1, 2 or 3,
with the proviso that the sum of e+f is less than or equal to 3 and in less than 50% of all units of the formula (II) in the organopolysiloxane resin the sum of e+f is equal to 2,
optionally
(4) water-insoluble organic compounds which differ from the triacylglycerides (1), and optionally
(5) alkaline or acidic catalysts or reaction products thereof with the components (1) to (4).

Surprisingly, it has been found that defoamer formulations based on triacylglycerides with fatty acid radicals having less than 16 carbon atoms have a very good effect. This also applies in particular to the applications described in which cationic surfactants are used, or to applications in which spreading plays an important role, such as in the rinsing cycle of the washing process.

The defoamer formulations (A) preferably comprise
100 parts by weight of triacylglycerides (1) and
at least 1 part by weight, preferably at least 1.5 parts by weight, particularly preferably at least 2 parts by weight, and at most 25 parts by weight, preferably at most 20 parts by weight, particularly preferably at most 15 parts by weight of fillers (2), based in each case on 100 parts by weight of (1),
at least 1 part by weight, preferably at least 1.5 parts by weight, particularly preferably at least 2 parts by weight, and at most 25 parts by weight, preferably at most 20 parts by weight, particularly preferably at most 15 parts by weight of organopolysiloxane resins (3), based in each case on 100 parts by weight of (1),
at least 0 parts by weight and at most 25 parts by weight, preferably at most 17 parts by weight, particularly preferably at most 10 parts by weight of water-insoluble organic compounds (4), based in each case on 100 parts by weight of (1),
at least 0 parts by weight, preferably at least 0.05 parts by weight, particularly preferably at least 0.1 parts by weight, and at most 2 parts by weight, preferably at most 1 part by weight, particularly preferably at most 0.5 parts by weight of alkaline or acidic catalysts (5) or reaction products thereof with the components (1) to (4), based in each case on 100 parts by weight of (1).

Examples of hydrocarbon radicals R are alkyl radicals or alkylene radicals, such as pentyl, pentenyl, hexyl, hexenyl, heptyl, heptenyl, octyl, octenyl, nonyl, nonenyl, decyl, decenyl, undecyl, undecenyl, dodecyl, dodecenyl, tridecyl and tridecenyl radicals. Preference is given to alkyl radicals.

Particularly preferred examples of R are the pentyl, heptyl, nonyl and undecyl radical.

The triacylglycerides (1) used in the defoamer formulation (A) are preferably triglycerides comprising medium-chain fatty acids. The medium-chain fatty acids include caproic acid (C 6:0), caprylic acid (C 8:0), capric acid (C 10:0) and lauric acid (C 12:0). In the nomenclature (C 6:0), “C 6” signifies the number of carbon atoms and “0” signifies the number of double bonds.

The triacylglycerides (1) used in the defoamer formulation (A) are obtained industrially by hydrolysis of coconut fat and palm kernel oil, subsequent fractionation of the medium-chain fatty acids and finally re-esterification with glycerol.

The triacylglycerides (1) may be triglycerides having predominantly only one type of fatty acid, for example Caprylic Triglyceride (INCI nomenclature), or else those having a mixture of fatty acids, for example Caprylic/Capric Triglyceride (INCI nomenclature).

Triacylglycerides (1) may also have a small amount (as impurity), preferably 0 to 10% by weight, in particular 0 to 5% by weight, of further fatty acid radicals which are longer-chained than 14 carbon atoms, e.g. the stearyl, palmityl, linolyl or linoleyl radical.

The triacylglycerides (1) also include the so-called MCT oils (medium chain triglycerides). Such oils are commercially available, e.g. as coconut-based MCT oil (Gustavhees) or as CremerCOOR® MCT C8, CremerCOOR® MCT 60-40 or CremerCOOR® MCT 30-70 (Cremer Oleo Division).

Preferably, R² is a hydrocarbon radical having 1 to 30 carbon atoms.

Examples of hydrocarbon radicals R² are alkyl radicals,
such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals, such as the n-hexyl radical; heptyl radicals, such as the n-heptyl radical; octyl radicals, such as the n-octyl radical and isooctyl radicals, such as the 2,2,4-trimethylpentyl and the 2-ethylhexyl radical; nonyl radicals, such as the n-nonyl radical; decyl radicals, such as the n-decyl radical; dodecyl radicals, such as the n-dodecyl radical; tetradecyl radicals, such as the n-tetradecyl radical; hexadecyl radicals, such as the n-hexadecyl radical and octadecyl radicals, such as the n-octadecyl radical; cycloalkyl radicals, such as the cyclopentyl, cyclohexyl, cycloheptyl, methylcyclohexyl and 4-ethylcyclohexyl radical; aryl radicals, such as the phenyl, naphthyl, anthryl and phenanthryl radical; alkaryl radicals, such as o-, m-, p-tolyl radicals, xylyl radicals and ethylphenyl radicals; and aralkyl radicals, such as the benzyl radical and the α- and β-phenylethyl radicals.

The hydrocarbon radicals R² may comprise ether or polyether groups.

Preferred examples of radicals R² are the methyl, ethyl and phenyl radical.

Examples of radicals R³ are the hydrogen atom and alkyl radicals, such as the methyl, ethyl, n-propyl, isopropyl and n-butyl radical.

The radical R³ is preferably a hydrogen atom or a methyl or ethyl radical.

Preferably, the fillers (2) used in the defoamer formulations according to the invention have a BET surface area of 20 to 1000 m²/g. Preferably, the fillers (2) have a particle size of less than 10 μm and an agglomerate size of less than 100 μm.

Examples of fillers (2) are silicon dioxide (silicas), titanium dioxide, aluminum oxide, metal soaps, quartz flour, PTFE powder, fatty acid amides, e.g. ethylene bisstearamide, and finely dispersed hydrophobic polyurethanes.

Silicas, in particular those having a BET surface area of 50 to 800 m²/g, are preferred as fillers (2). These silicas can be fumed or precipitated silicas. Both pre-treated silicas, i.e. hydrophobic silicas, and hydrophilic silicas can be used as fillers (2). Examples of commercially available hydrophobic silicas that can be used according to the invention are HDK® H2000, a fumed hexamethyldisilazane-treated silica having a BET surface area of 140 m²/g (commercially obtainable from Wacker-Chemie GmbH, Germany) and a precipitated polydimethylsiloxane-treated silica having a BET surface area of 90 m²/g (commercially obtainable under the name “Sipernat D10” from Evonik AG, Germany).

The component (3) used in the defoamer formulations according to the invention is preferably silicone resins composed of units of the formula (II), in which the sum of e+f is equal to 2 in less than 30%, preferably in less than 5%, of the units in the resin.

Preferably, the organopolysiloxane resins (3) composed of units of the formula (II) are MQ resins composed of units of the formulae
SiO₂ (Q units) and
R²₃SiO_{1/2} (M units),
where R² has the definition stated for it above.

The molar ratio of M to Q units in this case is preferably in the range from 0.5 to 2.0, preferably in the range from 0.6 to 1.0. In addition to the M and Q units, the MQ resins may optionally also comprise small amounts of R²SiO_{3/2} or (R³O)SiO_{3/2} (T) units or R²₂SiO_{2/2} (D) units, in amounts of preferably 0.01 to 20 mol %, preferably 0.01 to 5 mol %, based on the sum of all siloxane units, where R³ has the definition stated for it above. These MQ resins may also comprise up to 10% by weight of free Si-bonded hydroxyl or alkoxy groups, such as methoxy or ethoxy groups.

Preferably, these organopolysiloxane resins (3) have a viscosity of greater than 1000 mPa·s at 25° C. and 101.425 kPa or are solids. The weight-average molecular weight determined by gel permeation chromatography (based on a polystyrene standard) of these resins is preferably 200 to 200 000 g/mol, in particular 1000 to 20 000 g/mol.

In the defoamer formulations according to the invention, water-insoluble organic compounds (4) may optionally be used.

In the context of the present invention, the term “water-insoluble” is to be understood to mean a solubility in water at 25° C. and a pressure of 101.425 kPa of not more than 3% by weight.

The component (4) optionally used is preferably water-insoluble organic compounds having a boiling point greater than 100° C. at ambient pressure, i.e. at 900 to 1100 hPa, in particular those selected from hydrocarbons, polyisobutylenes and esters such as fatty acid esters with monoalcohols.

Examples of hydrocarbons are isoparaffins (for example obtainable under the trade names Isopar® E, Isopar® G, Isopar® H, Isopar® J, Isopar® L, Isopar® M, Isopar® N, Isopar® P, Isopar® V from ExxonMobil), dearomatized hydrocarbons (for example available under the trade names Exxsol® D40, Exxsol® 60, Exxsol® D95, Exxsol® D100, Exxsol® D130 from ExxonMobil) or white oils. Particular preference is given to dearomatized hydrocarbons.

Examples of polyisobutylenes are products commercially available under the trade name Indopol® (INEOS) or Oppanol® (BASF). Particularly preferred are those polyisobutylenes having a kinematic viscosity of 20 to 500 cSt measured at a temperature of 100° C. and a shear rate of 10 1/s.

Examples of esters, in particular fatty acid esters with monoalcohols, are e.g. methyl laurate, isopropyl laurate, octyl laurate, octyl stearate, octyl oleate, dodecyl palmitate or isopropyl myristate.

Examples of alkaline catalysts (5) optionally used are alkali metal hydroxides and alkaline earth metal hydroxides, such as NaOH, KOH, CsOH, LiOH and Ca(OH)₂.

Examples of acidic catalysts (5) are hydrochloric acid, sulfuric acid and phosphonitrilic chloride.

The reaction products of (5) with the components (1) to (4) are, for example, the product of the silica preferred as filler (2) with alkali metal hydroxides, such as potassium silicate or sodium silicate.

The metered addition of the catalysts can be effected in typical organic solvents such as alcohols (such as methanol, ethanol, isopropanol) or esters (such as ethyl acetate).

The components (2) to (5) used in the defoamer formulations (A) according to the invention may each be one type of such a component or else a mixture of at least two types of a respective component.

The defoamer formulations (A) according to the invention have a viscosity of preferably 50 to 100 000 mPa·s, particularly preferably of 100 to 10 000 mPa·s, especially of 200 to 5000 mPa·s, in each case at 25° C. and 101.425 kPa.

The defoamer formulation (A) according to the invention can be produced by known methods, such as by mixing all components, for example using high shear forces in colloid mills, dissolvers or rotor-stator homogenizers. The mixing process can be carried out at reduced pressure to prevent the mixing in of air, which is present, for example, in highly dispersed fillers. The fillers can then be hydrophobized in situ if required.

It is also possible to first initially charge the component (1) and optionally to heat it, and then to successively add the components (2), (3), optionally (4) and optionally (5). In a preferred embodiment, component (3) is added in dissolved form as a solution in component (4) or portions of component (4).

The invention further provides emulsions (E) of defoamer formulations comprising the defoamer formulations (A) according to the invention,
emulsifiers (B),
optionally thickeners (C) and
water (W).

To produce the defoamer emulsions (E) according to the invention, typical emulsifiers (B) known to those skilled in the art for example for producing silicone emulsions may be used, such as non-ionic, anionic or cationic emulsifiers.

Emulsifier mixtures are preferably used, wherein at least one non-ionic emulsifier should be present.

(Non-limiting) examples of non-ionic emulsifiers (B-1) used are:
1. Alkyl polyglycol ethers, preferably those having 3 to 30 EO units and alkyl radicals having 8 to 20 carbon atoms.
2. Carboxylic acid polyglycol esters, in particular fatty acid polyglycol esters, preferably those having more than 6 EO units and carboxylic acid radicals having 8 to 20 carbon atoms.
3. Ethoxylated or non-ethoxylated sorbitan fatty acid esters.
4. Ethoxylated castor oil or hydrogenated variants.
5. Polyglycerol carboxylic acid esters.
6. Alkyl polyglycosides of the general formula R*—O—Zₒ, in which R* is a linear or branched, saturated or unsaturated alkyl radical having an average of 8-24 carbon atoms and Zₒ is an oligoglycoside radical having an average of o=1-10 hexose or pentose units or mixtures thereof.
7. Alkylaryl polyglycol ethers, preferably those having 5 to 30 EO units and 8 to 20 carbon atoms in the alkyl and aryl radicals.
8. Ethylene oxide/propylene oxide (EO/PO) block copolymers, preferably those having 8 to 30 EO or PO units.
9. Polyvinyl alcohol still having 5% to 50%, preferably 8% to 20%, vinyl acetate units and having a degree of polymerization of 500 to 3000.
10. Addition products of alkylamines having alkyl radicals of 8 to 22 carbon atoms with ethylene oxide or propylene oxide.
11. Natural substances and derivatives thereof, such as lecithin, lanolin, saponins, cellulose; cellulose alkyl ethers and carboxyalkyl celluloses, the alkyl groups of which have in each case up to 4 carbon atoms.
12. Linear organo(poly)siloxanes containing polar groups containing in particular the elements O, N, C, S, P, Si, especially those having alkoxy groups with up to 24 carbon atoms and/or up to 40 EO and/or PO groups.

Preferred non-ionic emulsifiers (B-1) are
1. Alkyl polyglycol ethers, preferably those having 3 to 30 EO units and alkyl radicals having 8 to 20 carbon atoms
such as ceteareth-20, oleth-10, oleth-20, laureth-3, laureth-4, laureth-20, laureth-23, trideceth-5, trideceth-6, trideceth-8, trideceth-10, trideceth-12, trideceth-16, trideceth-20, steareth-20 or steareth-21 (according to INCI designation).
2. Carboxylic acid polyglycol esters, in particular fatty acid polyglycol esters, preferably those having more than 6 EO units and carboxylic acid radicals having 8 to 20 carbon atoms, such as PEG-20 stearate, PEG-20 laurate, PEG-7 olivate, PEG-8 oleate, PEG-8 laurate HLB PEG-6 stearate, PEG-20 stearate or PEG-100 stearate (according to INCI designation).
3. Ethoxylated or non-ethoxylated sorbitan fatty acid esters, such as sorbitan laurate, polysorbate 20, polysorbate 60, polysorbate 80 or polysorbate 85 (according to INCI designation).
4. Ethoxylated castor oil or hydrogenated variants, such as (designation according to INCI nomenclature) PEG 200 Castor Oil or PEG-60 Hydrogenated Castor Oil.
5. Polyglycerol carboxylic acid esters, such as polyglyceryl-10 oleate, polyglyceryl-10 laurate or polyglyceryl-10 stearate.
6. Alkyl polyglycosides of the general formula R*—O—Zₒ, in which R* is a linear or branched, saturated or unsaturated alkyl radical having an average of 8-24 carbon atoms and Zₒ is an oligoglycoside radical having an average of o=1-10 hexose or pentose units or mixtures thereof, such as Glucopon 215, Glucopon 225, Glucopon 600 (designation according to trade name).

(Non-limiting) examples of anionic emulsifiers (B-2) are:
1. Alkyl sulfates, particularly those having a chain length of 8 to 18 carbon atoms, alkyl and alkaryl ether sulfates having 8 to 18 carbon atoms in the hydrophobic radical, and 1 to 30 ethylene oxide (EO) and/or propylene oxide (PO) units.
2. Sulfonates, especially alkyl sulfonates having 8 to 18 carbon atoms, alkylaryl sulfonates having 8 to 18 carbon atoms.
3. Alkali metal and ammonium salts of carboxylic acids having 8 to 20 carbon atoms in the alkyl, aryl, alkaryl or aralkyl radical, in particular alkali metal and ammonium salts of fatty acids, preferably those having carboxylic acid radicals of 8 to 20 carbon atoms.

Preferred anionic emulsifiers (B-2) are alkali metal and ammonium salts of carboxylic acids having 8 to 20 carbon atoms in the alkyl, aryl, alkaryl or aralkyl radical, particularly preferred anionic emulsifiers are alkali metal and ammonium salts of fatty acids, preferably those having carboxylic acid radicals of 8 to 20 carbon atoms, such as sodium salts, potassium salts, triethanolammonium salts of lauric acid, myristic acid, palmitic acid, stearic acid or oleic acid.

(Non-limiting) examples of cationic emulsifiers (B-3) are:
1. Salts of primary, secondary, and tertiary fatty amines having 8 to 24 carbon atoms with acetic acid, sulfuric acid, hydrochloric acid, and phosphoric acids.
2. Alkylpyridinium, alkylimidazolinium, and alkyloxazolinium salts, especially those in which the alkyl chain has up to 18 carbon atoms, specifically the halides, sulfates, phosphates, and acetates.
3. Quaternary alkylammonium and alkylbenzeneammonium salts, especially those in which the alkyl groups have 6 to 24 carbon atoms, especially the halides, sulfates, phosphates and acetates

Furthermore, compounds known as thickeners (C) may be added, such as polyacrylic acid, polyacrylates, cellulose ethers such as carboxymethylcellulose and hydroxyethylcellulose, polyurethanes, natural thickeners, such as xanthan gum, and preservatives and other common additives known to those skilled in the art.

The continuous phase of the defoamer emulsions (E) according to the invention is preferably water. However, it is also possible to produce defoamer emulsions (E) according to the invention in which the continuous phase is formed by the components (1) or optionally (4).

These can also be multiple emulsions.

Methods for producing defoamer emulsions (E) are known. Typically, production is carried out by simply stirring all the constituents and, optionally, by subsequent homogenization using jet dispersers, rotor-stator homogenizers, colloid mills or high-pressure homogenizers.

The defoamer emulsions (E) according to the invention are preferably oil-in-water emulsions comprising
5 to 50% by weight of the defoamer formulation (A) according to the invention,
1 to 20% by weight of emulsifiers (B)
0 to 5% by weight of thickeners (C) and
25 to 94% by weight of water (W).

The compositions according to the invention can also be formulated as free-flowing powders (P). These are preferred, for example, when used in powdered detergents. These powders are produced, starting from defoamer formulation (A) according to the invention, by methods known to those skilled in the art, such as spray drying or build-up granulation and with additives known to those skilled in the art.

The invention further provides powders (P) comprising
the defoamer formulation (A) according to the invention and
support materials (T).

The powders (P) according to the invention preferably comprise 2 to 20% by weight of the defoamer formulation (A) according to the invention.

The supports (T) used include for example zeolites, sodium sulfate, sodium bicarbonate, sodium carbonate, cellulose derivatives, urea and also urea derivatives and sugar.

The powders (P) according to the invention comprise 80 to 98% by weight of support materials (T). Further constituents of the powders according to the invention may be, for example, waxes or organic polymers, as described, for example, in EP-A 887097 and EP-A 1060778.

The defoamer formulations (A) according to the invention and emulsions (E) or powders (P) thereof may be used wherever defoamer formulations based on organosilicon compounds have also been used to date.

This applies in particular to the control of foam in aqueous surfactant systems, for use in detergents and cleaning compositions, for the control of foam in wastewater plants, in textile dyeing processes, in natural gas scrubbing, in polymer dispersions, and for defoaming aqueous media resulting from production of pulp.

The present invention therefore further provides a process for defoaming and/or for preventing the foaming of media by mixing the defoamer formulations (A) according to the invention or emulsions (E) or powders (P) thereof with the media.

Preferably, the defoamer formulations (A) according to the invention are used for defoaming and/or for preventing the foaming of cationic surfactant systems or in applications in which spreading plays a significant role.

The defoamer formulations according to the invention can also be used in detergents and cleaning compositions and care products, such as fabric softeners, wherein the defoamer formulations (A) according to the invention can be used in bulk or in the form of emulsions (E) or powders (P).

The present invention therefore further provides detergents, cleaning compositions and laundry care compositions comprising the defoamer formulations (A) according to the invention or the defoamer formulations according to the invention in the form of emulsions (E) or in the form of powders (P).

The defoamer formulation according to the invention can be added directly to the foaming media, dissolved in suitable solvents, such as toluene, xylene, methyl ethyl ketone or tert-butanol, as a powder or as an emulsion. The amount required to achieve the desired defoaming effect depends, for example, on the type of medium, the temperature and the turbulence that occurs.

In the examples which follow, all figures for parts and percentages, unless stated otherwise, are based on weight. Unless stated otherwise, the examples which follow are conducted at a pressure of the surrounding atmosphere, i.e. at about 1000 hPa, and at room temperature, i.e. about 20° C., or a temperature which is established on combination of the reactants at room temperature without additional heating or cooling.

Dynamic viscosities were measured using an Anton Paar “MCR 302” rheometer according to DIN EN ISO 3219: 1994 and DIN 53019, wherein a cone and plate system (cone CP50-2) with an opening angle of 2° was used. The instrument was calibrated with standard oil 10000 from the Physikalisch-Technische Bundesanstalt [German Federal Physical-Technical Institute]. The measuring temperature is 25.00° C.+/−0.05° C., and the measuring time 3 min. The viscosity specification (reported in mPa·s) represents the arithmetic average of three independently performed individual measurements. The measurement uncertainty of the dynamic viscosity is 1.5%. The shear rate gradient was selected as a function of viscosity and is identified separately for each viscosity specification.

Kinematic viscosities are determined by means of a ViscoSystem® AVS 350 viscosity measuring system from Schott using Ubbelohde viscometer tubes with constant (e.g. from Windaus or VWR) in accordance with DIN 51562 Part 1 or ISO/DIS 3105 (including calibration thereof). The measurements are carried out at a temperature of 25.0° C. (+−0.1° C.). The viscosity specification (reported in mm²/s) represents the arithmetic average of three independently performed individual measurements: The measurement uncertainty of the kinematic viscosity is 1.05%. Depending on the measuring range, different viscometer tubes with corresponding directional constants are used:

| | | |
|---|---|---|
| Measuring range | Capillary No. | Directional constant |

| | | | |
|---|---|---|---|
| 0.5-3 | mm²/s | 0c | 0.003K |
| 0.8-5 | mm²/s | 0a | 0.005K |
| 1.2-10 | mm²/s | I | 0.01K |
| 3-30 | mm²/s | Ic | 0.03K |
| 10-100 | mm²/s | II | 0.10K |
| 30-300 | mm²/s | IIc | 0.30K |
| 100-1000 | mm²/s | III | 1K |
| 300-3000 | mm²/s | IIIc | 3K |
| 1000-10000 | mm²/s | IV | 10K |

Specification of the measuring range, the corresponding capillary no. and the constant in accordance with VWR laboratory catalogue, 2011-2013, p. 645.8.

### EXAMPLE 1

### Preparation of Defoamer Formulation (A1), (VA2) and (VA3), Defoamer Emulsions (E1) and (VE2) and Defoamer Powder (P1):

### A) Defoamer Formulation A1:

For the preparation of the defoamer formulation A1, 89 parts by weight of an MCT oil (commercially available from Gustavheess under the name MCT oil type V Ph. Eur. 10.0 with a content of saturated fatty acids having 8 or 10 carbon atoms of at least 95.0% by weight and a maximum of 1.0% by weight of ≥C16 fatty acids), 6 parts by weight of a precipitated silica (commercially available from Evonik under the name Sipernat® D 10), 2.5 parts by weight of a hydrocarbon mixture having a boiling range of 235-270° C. (commercially available under the name Exxsol D 100 S from Staub & Co Nuremberg, Germany) and 2.5 parts by weight of a silicone resin solid at room temperature consisting of the following units (according to ²⁹Si NMR and IR analysis): 40 mol % CH₃SiO_{1/2}—, 50 mol % SiO_{4/2}—, 8 mol % C₂H₅OSiO_{3/2}— and 2 mol % HOSiO_{3/2}—, with a weight-average molar mass of 7900 g/mol (based on polystyrene standard), were homogenized with a dissolver at 800 rpm for 10 min. The result is a low-viscosity defoamer formulation A1 having a viscosity of 305 mPa·s (at 25° C. and at a shear rate of 10 1/s).

### B) Non-Inventive Defoamer Formulation VA2:

For the preparation of the non-inventive defoamer formulation VA2, 85 parts by weight of soybean oil (commercially available from Gustavheess under the name hydrogenated soybean oil Ph. Eur. with a content of 9-13% by weight of palmitic acid, 17-30% by weight of oleic acid and isomers, 48-58% by weight of linoleic acid, 5-11% by weight of linolenic acid and a maximum of 0.1% by weight of <C14 fatty acids), 5 parts by weight of the precipitated silica from Example 1a), 5 parts by weight of the hydrocarbon mixture from Example 1a) and 5 parts by weight of the solid silicone resin from Example 1a) were homogenized with a dissolver at 800 rpm for 10 min. The result is a low-viscosity defoamer formulation VA2 having a viscosity of 840 mPa·s (at 25° C. and at a shear rate of 10 1/s).

### c) Non-Inventive Defoamer Formulation VA3:

The non-inventive defoamer formulation VA3 is prepared analogously to the preparation of the defoamer formulation VA2. Instead of soybean oil, the main component used was palm oil (commercially available from Gustavheess under the name hydrogenated palm oil Ph. Eur. having a content of ca. 35% by weight of palmitic acid, ca. 46% by weight of oleic acid, ca. 13.5% by weight of linoleic acid, 3.5% by weight of stearic acid and a maximum of 2.5% by weight of <C14 fatty acids). The result is a defoamer formulation VA3 having a viscosity of 300 000 mPa·s (at 25° C. and at a shear rate of 0.5 1/s).

### d) Defoamer Emulsion E1:

Defoamer emulsion E1 is prepared by mixing 10 parts by weight of an emulsifier mixture comprising an ethoxylated isotridecyl alcohol (HLB value of 11.2), an ethoxylated stearyl alcohol (HLB 9.7), pentaerythrityl distearate and ammonium lauryl sulfate with 20 parts by weight of the defoamer formulation A1 and 70 parts by weight of water using an Ultraturrax. Finally, 0.3 parts by weight of a biocidal mixture consisting of benzisothiazolinone and chloromethylisothiazolinone are added. The result is a milky-white emulsion having a viscosity of 220 mPa·s (at 25° C. and at a shear rate of 10 1/s).

### e) Non-Inventive Defoamer Formulation VE2:

The non-inventive defoamer emulsion VE2 is prepared analogously to the preparation of the defoamer formulation E1, wherein the defoamer formulation VA2 is used instead of the defoamer formulation A1. The result is a milky-white emulsion having a viscosity of 50 mPa·s (at 25° C. and at a shear rate of 10 1/s).

### f) Defoamer Powder P1:

56.3 g of sodium bicarbonate, 56.3 g of sodium sulfate and 15.0 g of a native cellulose, such as Arbocel UFC M8 (commercially available from Rettenmaier & Söhne) are initially charged in a glass beaker and mixed with each other with intensive mixing using a paddle stirrer. 22.5 g of the defoamer formulation A1 are added slowly with vigorous stirring. A white, free-flowing powder was obtained.

### EXAMPLE 2

### Tests of Defoamer Efficacy in the Washing Machine

A certain amount (see Table 1) of defoamer formulation A1 was added to 130 g of a washing powder ECE-2 from WFK. The washing powder was then placed in a drum washing machine (type Miele Novotronik W918 without Fuzzy Logic) together with 3500 g of clean cotton laundry. The washing program is then started. The program runs at a temperature of 40° C. and a water hardness of 3° GH. The foam height is recorded over a period of 55 minutes. The average foam score is determined from the foam scores determined over the entire period (0% no foam measurable up to 100% overfoaming). The lower this is, the more effective the defoamer formulation is over the entire period.

TABLE 1
Defoaming effect of the defoamer formulation
A1 in a washing machine:

| Defoamer | Quantity per 100 g of washing | |
|---|---|---|
| formulation | powder | Average foam score |
| A1 | 0.5 g | 7% |

The defoamer formulation A1 has an excellent anti-foam effect over the entire washing period.

### EXAMPLE 3

### Test of Efficacy as Defoamer for Surfactant Residues in the Rinse Cycle

5.0 l of tap water (16° GH) are added to an 8 l plastic bowl. 20 g of ECE-2 washing powder from WFK are added and dispersed by hand. A terry towel (100% cotton, 45×45 cm, ca. 100 g, ca. 490 g/m², pre-washed twice in the washing machine) is placed in the washing solution, dipped in several times, squeezed out and left to soak. The terry towel is removed and wrung out to a total weight of 350 g.

A rinse solution (in another 8 l plastic bowl) consisting of 5 l of tap water (16° GH) and 15 g of a cationic surfactant solution is prepared. The cationic surfactant solution is a 11.1% by weight aqueous solution of Stepantex® VK 90 (9:1 mixture of methyl bis[ethyl(tallowate)]-2-hydroxyethyl ammonium methyl sulfate with isopropanol; commercially available from Stepan). Depending on the experiment (see Table 2), the specified amounts of defoamer formulation or emulsion are added.

The wet terry towel is placed in the rinse solution, taken out again and wrung out to create foam. This procedure is repeated three times. Finally, after 30 seconds, a photo is taken to evaluate the resulting foam on the surface of the rinse solution.

TABLE 2
Cationic surfactant formulations:

| | | Amount of defoamer |
|---|---|---|
| Aqueous cationic | Amount of cationic | formulation or |
| surfactant solution | surfactant (*) | emulsion |
| K1 | 11.1% by weight | — |
| K2 | 11.1% by weight | 0.025% by weight of A1 |
| K3 | 11.1% by weight | 0.125% by weight of E1 |
| K4 | 11.1% by weight | 0.125% by weight of VE2 |

(*) methyl bis[ethyl(tallowate)]-2-hydroxyethyl ammonium methyl sulfate (commercially available from Stepan under the name Stepantex ® VK 90, 9:1 mixture with isopropanol)

TABLE 3
Evaluation of defoamer efficacy:

| Cationic surfactant | |
|---|---|
| solution | Defoamer efficacy |
| K1 | − |
| K2 | +++ |
| K3 | ++ |
| K4 | − |

− No foam reduction (<30% foam reduction)
+ Slight foam reduction (30-50% foam reduction)
++ Good foam reduction (50-75% foam reduction)
+++ Very good foam reduction (>75% foam reduction)

Cationic surfactant formulation K2 comprising defoamer formulation A1 shows excellent defoamer efficacy compared to the blank value K1 (without defoamer formulation). This also applies to the cationic surfactant formulation K3 comprising emulsion E1 (again comprising A1). In contrast, the (non-inventive) defoamer emulsion VE2 (based on triacylglycerides having >C14 fatty acid radicals as the main component) does not show any defoaming effect.

### EXAMPLE 4

### Test of Defoamer Efficacy in an Aqueous Cationic Surfactant Solution

20 ml of a cationic surfactant solution are placed in a 50 ml BRAND® PP centrifuge tube. Methyl bis[ethyl(tallowate)]-2-hydroxyethyl ammonium methyl sulfate (commercially available from Stepan under the name Stepantex® VK 90, 9:1 mixture with isopropanol) is used as cationic surfactant. The amount of cationic surfactant is varied according to the figures in Table 4. The defoamer formulation is added to the cationic surfactant solution and the solution is stirred to distribute the defoamer formulation evenly.

Using an Ultra Turrax disperser (ULTRA-TURRAX T 25 from IKA-Labortechnik, equipped with an S 25 N-10 G dispersing tool), the cationic surfactant solution is sheared at 20 000 rpm for 1 min. The disperser is removed and the resulting foam height is determined after 60 seconds.

TABLE 4
Defoaming effect of the defoamer formulations
A1 and VA3 in a cationic surfactant solution:

| Concentration of the | | | Foam height after 60 sec. | |
|---|---|---|---|---|
| cationic surfactant in the | Foam height after 60 sec. | | Defoamer formulation | |
| cationic surfactant solution | Defoamer formulation A1 | | VA3 | |
| 4% by weight | 3 | ml | 15 | ml |
| 5% by weight | 1 | ml | 12 | ml |
| 6% by weight | 0 | ml | 11 | ml |
| 7% by weight | 1 | ml | 9 | ml |
| 8% by weight | 0 | ml | 8 | ml |
| 9% by weight | 3 | ml | 9 | ml |
| 10% by weight | 4 | ml | 7 | ml |

(Quantity of 0.1% by weight of the defoamer formulation A1 or VA3 in the cationic surfactant solution)

The defoamer formulation A1 shows a better defoaming effect over the entire concentration range of the cationic surfactant solution compared to defoamer formulation VA3.

### EXAMPLE 5

### Test of Defoamer Efficacy of the Defoamer Powder P1 According to the Invention During the Washing Process in the Dishwasher:

To 20 g of a defoamer-free dishwashing powder (comprising sodium citrate dihydrate, sodium carbonate, sodium sulfate, sodium bicarbonate, sodium percarbonate, tetrasodium etidronate and ceteareth-25) was added a certain amount (see Table 5) of the defoamer powder P1. The washing powder was then placed in the washing compartment of a dishwasher (type Bauknecht GSF 50204). The washing program is then started without crockery. The program runs at a temperature of 40° C. and a water hardness of 16° GH. The foam height is determined via the spray pressure. The spray pressure gives an indication of foam development during the washing process. If only water is pumped, the spray pressure is ca. 300 mbar. If the spray pressure drops, a water/foam mixture is being pumped. The lower the spray pressure drops, the more foam is in the dishwasher. The minimum spray pressure is recorded.

TABLE 5
Defoaming effect of the defoamer formulations P1 in the dishwasher:

| Amount used of defoamer | Minimum spray pressure | | |
|---|---|---|---|
| powder | (Mean of 3 measurements | | Comment |
| 2% by weight of P1 | 248 | mbar | Hardly any foam formation |
| No defoamer | 36 | mbar | Very high foam formation |

The defoamer powder P1 (comprising defoamer formulation A1) exhibits a very good effect in controlling the foam during the washing process in the dishwasher.

1-11. (canceled)

12. A defoamer formulation (A) comprising
(1) 100 parts by weight of triacylglycerides of the formula 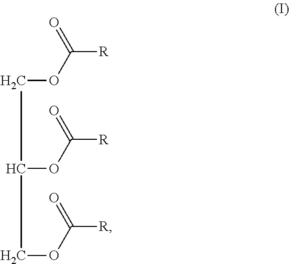
where
R may be the same or different and is a saturated or unsaturated C₅-C₁₃ hydrocarbon radical,
(2) at least 1 part by weight and at most 25 parts by weight of fillers, based on 100 parts by weight of (1),
(3) at least 1 part by weight and at most 25 parts by weight of organopolysiloxane resins, based on 100 parts by weight of (1), composed of units of the general formula
R²ₑ(R³O)_{f}SiO_{(4-e-f)/2} (II),
where
R² may be the same or different and is a hydrogen atom or a monovalent, optionally substituted, SiC-bonded hydrocarbon radical having 1 to 30 carbon atoms,
R³ may be the same or different and is a hydrogen atom or a monovalent, optionally substituted, hydrocarbon radical having 1 to 4 carbon atoms,
e is 0, 1, 2 or 3 and
f is 0, 1, 2 or 3,
with the proviso that the sum of e+f is less than or equal to 3 and in less than 50% of all units of the formula (II) in the organopolysiloxane resin the sum of e+f is equal to 2,
optionally
(4) at least 0 parts by weight and at most 25 parts by weight of water-insoluble organic compounds, based on 100 parts by weight of (1), which differ from the triacylglycerides (1),
and optionally
(5) at least 0 parts by weight and at most 2 parts by weight of alkaline or acidic catalysts or reaction products thereof with the components (1) to (4), based on 100 parts by weight of (1).

13. The defoamer formulations (A) as claimed in claim 12, wherein said formulations are triglycerides comprising medium-chain fatty acids selected from caproic acid (C 6:0), caprylic acid (C 8:0), capric acid (C 10:0) and lauric acid (C 12:0), where in the nomenclature (C 6:0), (C 8:0), (C 10:0) and (C 12:0), “C 6”, “C 8”, “C 10” and “C 12” is in each case the number of carbon atoms and the “0” signifies the number of double bonds.

14. The defoamer formulation as claimed in claim 12, wherein silicas are used as fillers (2).

15. The defoamer formulation (A) as claimed in claim 12, wherein the organopolysiloxane resins (3) used are MQ resins composed of units of the formulae
SiO₂ (Q units) and
R²₃SiO_{1/2} (M units),
where the molar ratio of M to Q units is in the range from 0.5 to 2.0, the MQ resins may also comprise, in addition to the M and Q units, small amounts of R²SiO_{3/2} or (R³O)SiO_{3/2} (T) units or R²₂SiO_{2/2} (D) units, in amounts from 0.01 to 20 mol %, based on the sum of all siloxane units, and the MQ resins may comprise up to 10% by weight of free Si-bonded hydroxyl or alkoxy groups, such as methoxy or ethoxy groups,
where R² and R³ are as defined in claim 1.

16. The defoamer formulation (A) as claimed in claim 12, wherein the water-insoluble organic compounds (4) used, which differ from the triglycerides (1), are those having a boiling point greater than 100° C. at 900 to 1100 hPa.

17. An emulsion (E) of defoamer formulations comprising
defoamer formulations (A) as claimed in claim 12,
emulsifiers (B),
optionally thickeners (C) and
water (W).

18. A powder (P) comprising
defoamer formulations (A) as claimed in claim 12 and
support materials (T).

19. A detergent, cleaning composition or laundry care composition comprising the defoamer formulation (A) as claimed in claim 12.

20. A detergent, cleaning composition or laundry care composition comprising the emulsion (E) as claimed in claim 17.

21. A detergent, cleaning composition or laundry care composition comprising the powder (P) as claimed in claim 18.

22. A process for defoaming and/or for preventing foaming of media by mixing the defoamer formulation (A) as claimed in claim 12 with the media.

23. A process for defoaming and/or for preventing foaming of media by mixing the emulsion (E) as claimed in claim 17 with the media.

24. A process for defoaming and/or for preventing foaming of media by mixing the powder (P) as claimed in claim 18 with the media.

25. The use of the defoamer formulation (A) as claimed in claim 12 for defoaming and/or for preventing foaming in cationic surfactant systems or in the washing cycle of the washing process.

26. The use of the emulsion (E) as claimed in claim 17 for defoaming and/or for preventing foaming in cationic surfactant systems or in the washing cycle of the washing process.

27. The use of the powder (P) as claimed in claim 18 for defoaming and/or for preventing foaming in cationic surfactant systems or in the washing cycle of the washing process.
